(19) United States
(12) Patent Application Publication
(10) Pub. No.: US 2015/0261464 A1
(43) Pub. Date: Sep. 17, 2015

(54) MEMORY SYSTEM AND METHOD OF CONTROLLING MEMORY SYSTEM

(71) Applicant: Kabushiki Kaisha Toshiba, Minato-ku (JP)

(72) Inventor: Kazuma FUJIWARA, Yokohama (JP)

(73) Assignee: Kabushiki Kaisha Toshiba, Minato-ku (JP)

(21) Appl. No.: 14/475,718

(22) Filed: Sep. 3, 2014

Related U.S. Application Data
(60) Provisional application No. 61/950,899, filed on Mar. 11, 2014.

(51) Int. Cl. G06F 3/06

(52) U.S. Cl. CPC G06F 3/0619; G06F 3/0688; G06F 3/065; G06F 3/0659

(57) ABSTRACT

According to an embodiment, a controller transfers, when first data in second management unit larger than a first management unit is stored in a second buffer, the first data stored in the second buffer to a first host through a first port. After the transfer, the controller deletes second data stored in the first buffer, the second data being the same data as the transferred first data and stores second read data following the first read data in the first buffer and the second buffer in the first management unit.

### CROSS-REFERENCE TO RELATED APPLICATIONS

This application is based upon and claims the benefit of priority from U.S. Provisional Patent Application No. 61/950,899, filed on Mar. 11, 2014; the entire contents of which are incorporated herein by reference.

### FIELD

Embodiments of the present invention relate to a control method of a memory system and a memory system.

### BACKGROUND

A storage device including a NAND flash memory as a non-volatile memory such as an SSD (solid state drive) is widely used in an electronic device and the like in recent years. The SSD is connected to a host device such as a personal computer through a communication interface such as an SAS (serial attached SCSI).

In the interface such as the SAS, a transport layer being a lower layer handles data in frame unit and an application layer being a higher layer handles the data in sector unit. It is desired to efficiently communicate the data between the transport layer and the application layer using different units in handling the data in order to improve data transfer efficiency between the SSD and the host device.

### BRIEF DESCRIPTION OF THE DRAWINGS

FIG. 1 is a view of a configuration of a memory system of a first embodiment.

FIG. 2 is a flowchart of a control method of the memory system of the first embodiment.

FIG. 3 is a view of a state of a frame buffer and a pool buffer in the control method of the memory system of the first embodiment.

FIG. 4A is a view of a state of the frame buffer and the pool buffer in the control method of the memory system of the first embodiment.

FIG. 4B is a view of a state of the frame buffer and the pool buffer in the control method of the memory system of the first embodiment.

FIG. 4C is a view of a state of the frame buffer and the pool buffer in the control method of the memory system of the first embodiment.

FIG. 5 is a view of a relationship between sector data and frame data of the first embodiment.

FIG. 6 is a view of a configuration of a memory system of a second embodiment.

FIG. 7 is a view of a configuration of a memory system of a third embodiment.

### DETAILED DESCRIPTION

According to an embodiment, a memory system comprises a non-volatile storage unit, a first buffer, a second buffer, a first port, and a controller, the first port being capable of communicating with a first host. The controller reads first read data from the non-volatile storage unit when receiving a read request from the first host. The controller stores the first read data in the first buffer and the second buffer in first management unit. The controller transfers, when first data in second management unit is stored in the second buffer, the first data stored in the second buffer to the first host through the first port. the second management unit is larger than the first management unit. After the transfer, the controller deletes second data stored in the first buffer, the second data being the same data as the transferred first data, and stores second read data following the first read data in the first buffer and the second buffer in the first management unit.

The control method of the memory system and the memory system according to the embodiments are hereinafter described in detail with reference to the attached drawings. Meanwhile, the present invention is not limited by the embodiments.

### First Embodiment

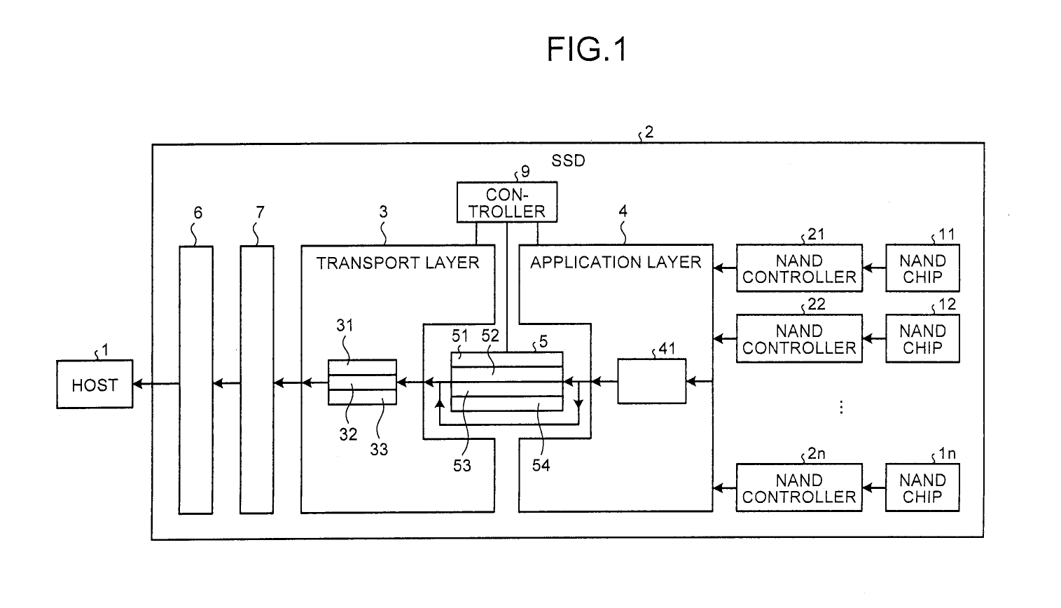

FIG. 1 is a view of a configuration of a memory system 2 of a first embodiment. The memory system 2 is an SSD (solid state drive), for example. The memory system 2 is connected to a host 1 such as a personal computer and a server through a communication interface such as an SAS. The memory system 2 serves as an external storage device of the host 1, for example.

The memory system 2 is provided with a front end serving as an SAS controller. The SAS controller includes a transport layer 3, an application layer 4, a controller 9, a physical layer 6, a link layer 7, and a pool 5. The memory system 2 is provided with a non-volatile memory and a controller of the non-volatile memory as a back end. The non-volatile memory includes a non-volatile semiconductor memory such as a NAND flash memory. The non-volatile semiconductor memory is not limited to the NAND flash memory and this may include another non-volatile semiconductor memory such as a NOR flash memory and an MRAM (magnetic random access memory). Furthermore, the non-volatile memory may be a magnetic disk, a magnetic card, a magnetic drum and the like, for example. The memory system 2 is herein provided with NAND controllers 21 to 2n as the controllers of the non-volatile memories and NAND chips 11 to 1n as the non-volatile memories, for example. Meanwhile, the transport layer 3, the application layer 4, and the controller 9 may form one controller as a whole.

In the application layer 4, data is handled in sector unit (first management unit). In contrast, in the physical layer 6, the link layer 7, and the transport layer 3, the data is handled in frame unit (second management unit). Data unit of one sector is smaller than the data unit of one frame. The data unit of one sector may have values of 512 bytes, 520 bytes, and 528 bytes, for example, but the data unit of one frame is defined as 1024 bytes at a maximum in the SAS standard, for example. A case in which the data unit of one sector is 520 bytes is hereinafter described as an example.

The transport layer 3 is provided with three frame buffers 31 to 33 each of which is a buffer capable of storing the data in the frame unit. The number of the frame buffers is not necessarily three. A link is opened between the memory system 2 and the host 1 and the data stored in the frame buffers 31 to 33 is transferred to the host 1 through the link layer 7 and the physical layer 6. The application layer 4 is provided with a sector buffer 41 being a buffer capable of storing the data in the sector unit. The pool 5 is provided with pool buffers 51 to 54 each of which is a buffer capable of storing the data in the frame unit. The sector buffer 41 may store the same data in the frame buffers 31 to 33 and the pool buffers 51 to 54 in the sector unit.

A TAG as an identifier uniquely assigned for each read command from the host 1 is related to read data from the NAND chips 11 to 1n. For example, there is a case in which all of the frame buffers 31 to 33 are used for the read data of the same TAG and a case in which the frame buffers 31 to 33 are used for the read data of the different TAGs. In contrast, the pool buffers 51 to 54 are used for the read data of the different TAGs. Although four pool buffers 51 to 54 are illustrated for the sake of simplification in this embodiment, the number of the pool buffers may be the same as the number of types of the TAGs, for example, 64.

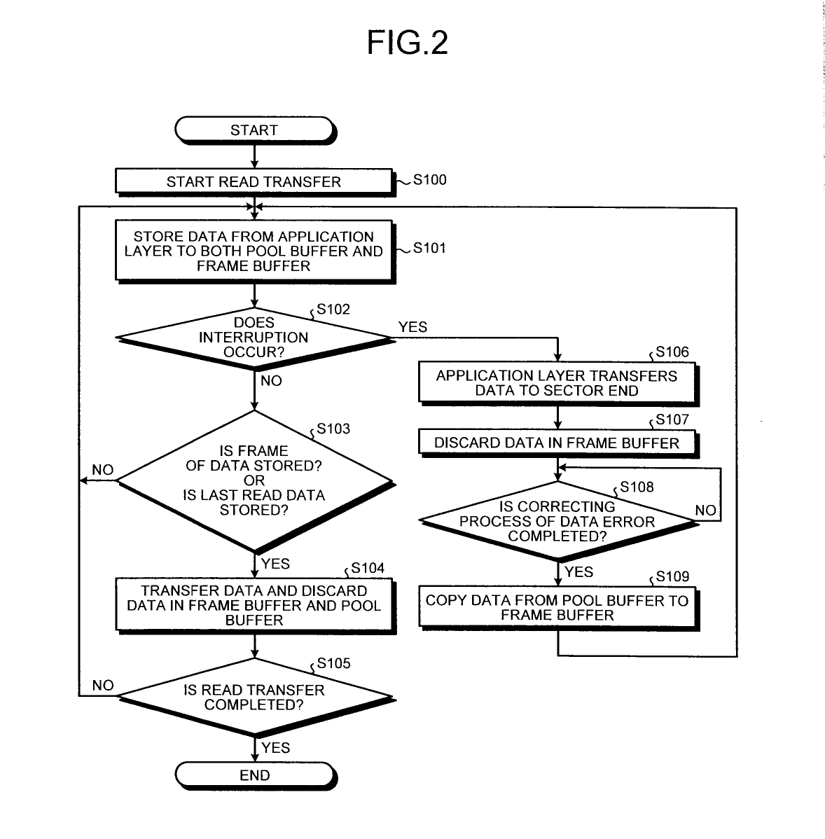

The control method of the memory system 2 is hereinafter described with reference to a flowchart in FIG. 2. The memory system 2 starts read transfer in response to the read command received from the host 1 at step S100. The read transfer refers to transmission of the read data from the non-volatile memory to the host 1. Specifically, the data is read from the NAND chips 11 to 1n in response to the read command, the read data is stored in the sector buffer 41, and the data in the sector buffer 41 is temporarily stored in a first buffer and a second buffer. The first buffer is the frame buffer 31, for example, and the second buffer is the pool buffer 51, for example. Thereafter, the data stored in the frame buffer 31 is transmitted to the host 1.

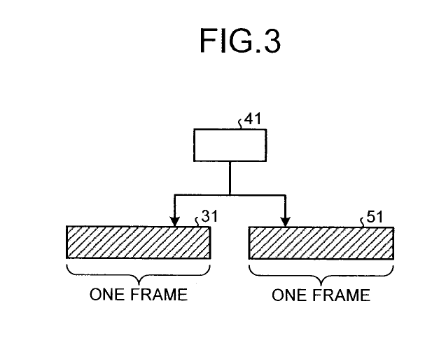

First, the application layer 4 stores the data stored in the sector buffer 41 in the frame buffer 31 and the pool buffer 51 in the sector unit, for example (step S101). A state at that time is illustrated in FIG. 3. A hatched line in FIG. 3 indicates that one frame of same data transferred from the sector buffer 41 is stored in the frame buffer 31 and the pool buffer 51. An arrow in FIG. 3 indicates a flow of the data transferred from the sector buffer 41. The storage of the data in the sector unit is not necessarily continuously performed in terms of time and the data might be intermittently stored in the sector unit. Next, the controller 9 determines whether an interruption to be described later occurs (step S102), and when this does not occur (step S102: No), the procedure shifts to step S103.

At step S103, the transport layer 3 determines whether the one frame of data is stored in the frame buffer 31 or whether last data smaller than one frame out of the read data corresponding to the read command received from the host is stored in the frame buffer 31. When the one frame of data is stored or when the last data smaller than one frame of the read data is stored in the frame buffer 31 (step S103: Yes), the transport layer 3 transfers the data stored in the frame buffer 31 to the host 1 and discards the data in the frame buffer 31 (step S104). According to this, only the frame which finally transfers the data transmitted by one read command from the host 1 is required to transfer the data smaller than one frame. At that time, since the same data as the data transferred from the frame buffer 31 to the host 1 is stored in the pool buffer 51, the controller 9 discards the data in the pool buffer 51 (step S104). When a condition at step S103 is not satisfied (step S103: No), the procedure returns to step S101.

After step S104, the controller 9 determines whether the read transfer is completed at step S105. Specifically, it is determined whether the transfer to the host 1 of the read data having a data transfer length indicated by the read command from the host 1 is completed. If this is not completed (step S105: No), the procedure returns to step S101, and when this is completed (step S104: Yes), the procedure is finished.

When the interruption occurs at step S102 (step S102: Yes), the procedure shifts to step S106. The interruption refers to a situation in which the read data following the read data normally stored in the sector buffer 41 does not arrive at the sector buffer 41 due to detection and correction of a data error at the back end such as the NAND controllers 21 to 2n and the NAND chips 11 to 1n and the detection and correction of the data error at the application layer 4, for example. There also is a case in which the transport layer 3 requires the application layer 4 to interrupt by an instruction from the host 1, for example. Such an SAS command includes AIP (arbitration in progress) and the like as an example.

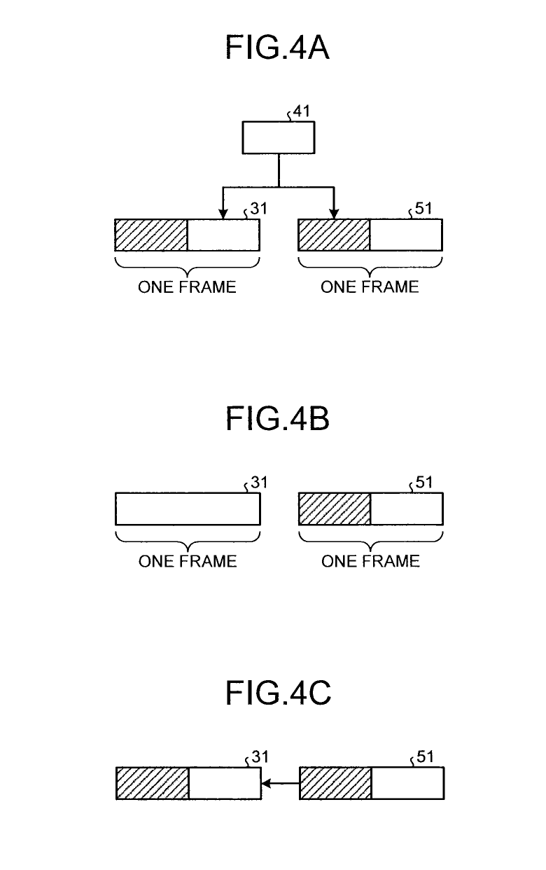

When the interruption occurs, the transport layer 3 transfers all data in the frame unit stored in the frame buffers 31 to 33 to the host 1 through the link layer 7 and the physical layer 6, and the application layer 4 stores the data in the sector buffer 41 not yet transferred smaller than one frame in the frame buffer 31 and the pool buffer 51, for example, in the sector unit as illustrated in FIG. 4A (step S106). A hatched line in FIG. 4A indicates that the data smaller than one frame transferred from the sector buffer 41 is stored in the frame buffer 31 and the pool buffer 51. An arrow in FIG. 4A indicates a flow of the data transferred from the sector buffer 41. Thereafter, the transport layer 3 discards the data in the frame buffer 31 as illustrated in FIG. 4B (step S107). The system to which the SAS standard is applied opens the link with the host 1 through the link layer 7 and the physical layer 6 when the data is present in the frame buffer 31 to transmit the data stored in the frame buffer 31 to the host 1. Therefore, it is possible that the transport layer 3 discards the data in the frame buffer 31, thereby preventing the link with the host 1 from being opened when the data smaller than one frame is stored in the frame buffer 31.

Thereafter, the controller 9 resolves a cause of the above-described interruption and the controller 9 determines whether a correcting process of the data error is completed in order to determine whether the data transfer may be started again (step S108). When the correcting process of the data error is not completed (step S108: No), the procedure returns to step S108, and when the correcting process is completed (step S108: Yes), the controller 9 copies the data not yet transferred smaller than one frame remaining in the pool buffer 51 to the frame buffer 31 as illustrated in FIG. 4C (step S109). An arrow in FIG. 4C indicates a flow of the data from the pool buffer 51 to the frame buffer 31. After step S109, the procedure shifts to step S101.

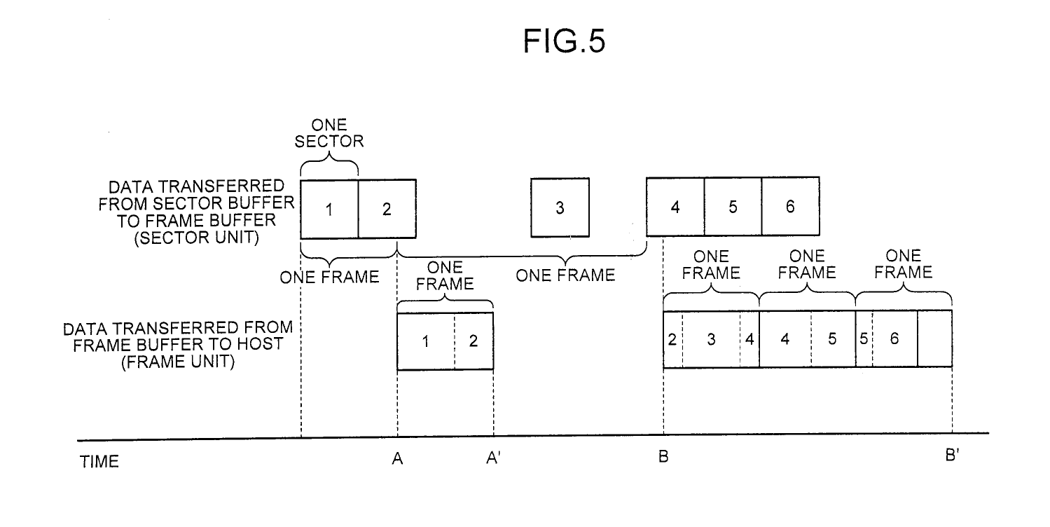

FIG. 5 is a view of a relationship between transfer timing of the data transferred from the sector buffer 41 to the frame buffer 31 in the sector unit and timing of the data transferred from the frame buffer 31 to the host 1 in the frame unit. The link is opened at time A, the frame is transferred from the frame buffer 31 to the host 1, and the link is closed at time A′ when the transfer is finished. The link is opened again at time B, the frame is transferred from the frame buffer 31 to the host 1, and the link is closed at time B′ when the transfer is finished. According to the control method of the memory system of this embodiment, when the interruption occurs during the data transfer from the sector buffer 41, the data smaller than one frame in the frame buffer 31 is discarded and the same data as the discarded data remains in the pool buffer 51. According to this, as illustrated in FIG. 5, it becomes possible to avoid a situation in which the link with the host 1 is opened from time A′ at which the link is closed to time B at which the links is opened again and the data in the frame buffer 31 is transferred to the host 1. Each of data in the sector unit indicated by numbers “1” to “6” in FIG. 5 represents contents of the data read from the non-volatile memory by the read command to be transferred from the sector buffer 41 to the frame buffer 31 in the sector unit. Another frame of data is accumulated in the frame buffer 31 after time A′, the link is opened between the host 1 and the frame buffer 31 and it becomes possible to execute the data transfer from time B. At that time, the data “2” at the top of the frame transferred first to the host 1 from time B is the data copied from the pool buffer 51 to the frame buffer 31 as illustrated in FIG. 4C. In FIG. 5, the data other than the data “2” out of the data transferred from the frame buffer 31 to the host 1 after time B are the data transferred from the sector buffer 41 to the frame buffer 31. As a result, it becomes possible to reduce the number of data frames transferred to the host 1, thereby reducing the number of times of opening/closing of the link.

According to the first embodiment, when sector data is stored in the frame buffer, it becomes possible to discard the data in the frame buffer when the transfer is interrupted by storing the copy of the data stored in the frame buffer at that time in the pool buffer. When the transfer is started again, it is not required to unnecessarily open the link by following a procedure to store the data stored in the pool buffer in the frame buffer and add the sector data to the frame buffer and the pool buffer. That is to say, it becomes possible to reduce frequency of the link opening, thereby improving data transfer efficiency of the memory system by keeping the data smaller than one frame in the pool and minimizing the transfer of the frame including the data smaller than one frame.

### Second Embodiment

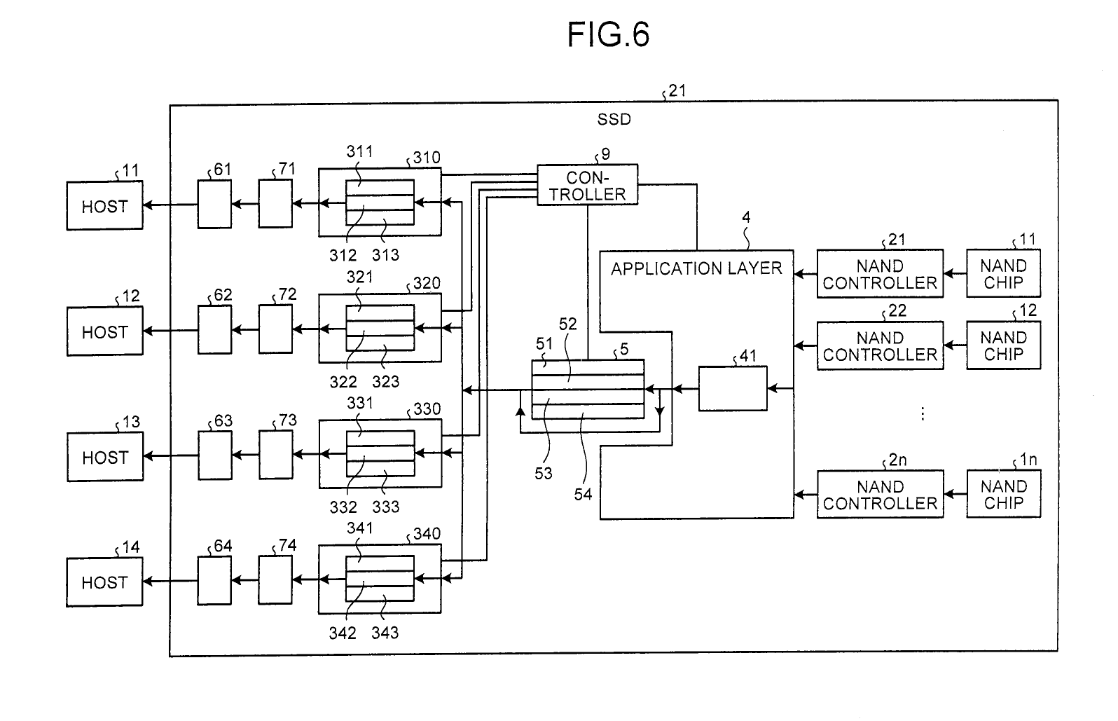

FIG. 6 is a view of a configuration of a memory system 21 of a second embodiment. The memory system 21 includes a plurality of ports each of which may be connected to one host. FIG. 6 illustrates a case in which the memory system 21 is provided with four ports as an example, and multi-port connection to connect hosts 11 to 14 to respective ports is possible. The memory system 21 is provided with physical layers 61 to 64, link layers 71 to 74, and transport layers 310 to 340 corresponding to the hosts 11 to 14, respectively. The transport layers 310 to 340 are provided with frame buffers 311 to 313, 321 to 323, 331 to 333, and 341 to 343, respectively. A pool 5 is shared by the transport layers 310 to 340 and pool buffers 51 to 54 in the pool 5 are used for TAGs corresponding to read commands from the hosts 11 to 14, respectively.

Operation similar to that of the first embodiment may be executed in response to the read command from a specific host such as the host 11 by using the frame buffer 311 and the pool buffer 51.

For example, when the host 11 and the host 12 are the same host, that is to say, when one host is connected to two ports of the memory system 21, the physical layers 61 and 62 may be used. In the memory system 21, it is possible to execute read operation as in the first embodiment by using the frame buffer 311 (first buffer) of the transport layer 310 and the pool buffer 51 (second buffer). However, there is a case in which the physical layer 61 becomes unusable for some reason and data transfer is interrupted in the read operation. In such a case, in this embodiment, it is possible to continue the read operation by using the data stored in the frame buffer 321 (third buffer) of the transport layer 320 and the pool buffer 51, for example, after the interruption. Specifically, the data remaining in the pool buffer 51 at the end of interrupted read operation using the frame buffer 311 and the pool buffer 51 may be copied to the frame buffer 321 to continue the read operation. The data read to the frame buffer 321 is thereafter transferred to the host through the link layer 72 and the physical layer 62. Meanwhile, if the data remaining in the pool buffer 51 is copied to the frame buffer 311, the operation is similar to that of the first embodiment.

According to the second embodiment, a plurality of transport layers 310 to 340 is provided so as to support the multi-port connection and the shared pool buffer is used. As a result, it becomes possible to improve data transfer efficiency also in the memory system supporting the multi-port connection.

### Third Embodiment

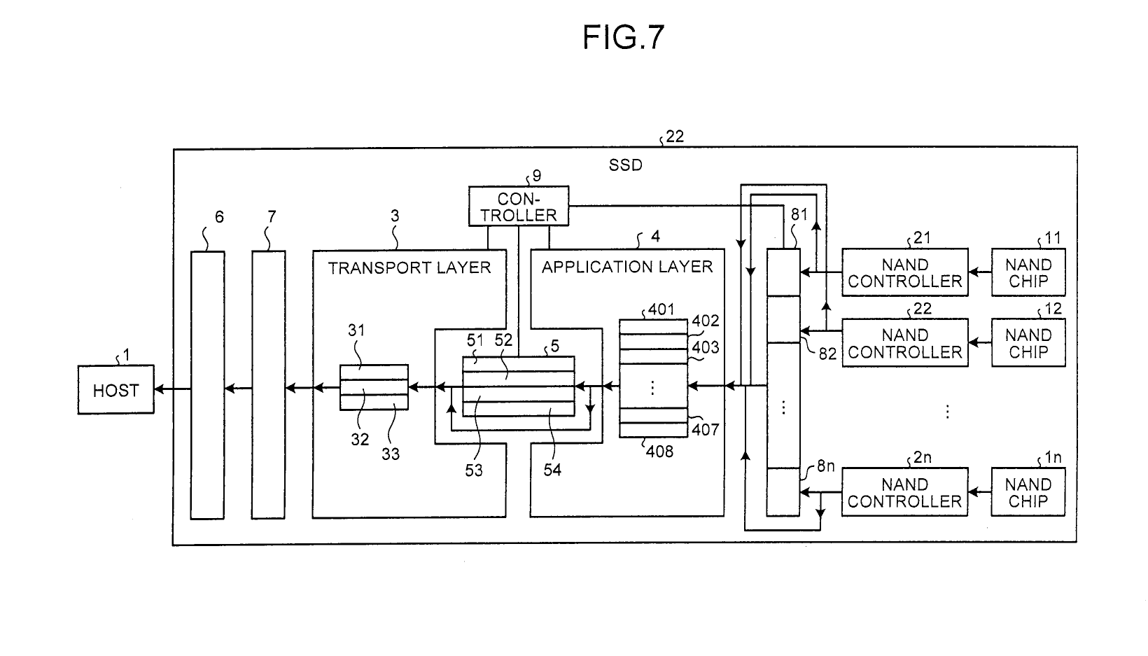

FIG. 7 is a view of a configuration of a memory system 22 of a third embodiment. FIG. 7 is different from FIG. 1 in that sector buffers 401 to 408 (fourth buffers) for eight sectors are provided in an application layer 4 and pool buffers 81 to 8n (fifth buffers) are provided between the sector buffers 401 to 408 and NAND controllers 21 to 2n, respectively. The pool buffers 81 to 8n store one cluster of read data from the NAND controllers 21 to 2n, respectively. The sector buffers 401 to 408 may store one sector of data. For example, one cluster equals to eight sectors. Therefore, the sector buffers 401 to 408 may store one cluster of data as a whole. The NAND controllers 21 to 2n handle the data in cluster unit (third management unit) with a data amount larger than that with sector unit (second management unit) while the application layer 4 handles the data in the sector unit. Therefore, the pool buffers 81 to 8n which store the data in the cluster unit are provided. The pool buffers 81 to 8n are controlled by a controller 9.

In this embodiment, the data in the cluster unit is converted to the data in the sector unit by using the sector buffers 401 to 408 and the pool buffers 8.

That is to say, the NAND controller 21 stores the read data from the NAND chip 11 to both the sector buffers 401 to 408 and the pool buffer 81 in the cluster unit. When transfer of one cluster of data to the sector buffers 401 to 408 is completed, the controller 9 clears the data in the pool buffer 81. Therefore, when an interruption occurs when only the data smaller than eight sectors is read to the sector buffers 401 to 408, one cluster of data is stored in the pool buffer 81.

The data in the sector buffers 401 to 408 is transferred to the frame buffer 31 and the pool buffer 51 each time one sector of data is complete in the order from the sector buffer 401 to the sector buffer 408. Therefore, each time the data is transferred from the sector buffers 401 to 408 to the frame buffer 31 and the pool buffer 51, the data in the sector buffers 401 to 408 is discarded by one sector. When the data transfer to the sector buffers 401 to 408 is started again after the interruption, the controller 9 copies the data not yet transferred from the sector buffers 401 to 408 to the frame buffer 31 and the pool buffer 51 out of the one cluster data in the pool buffer 81 to the sector buffers 401 to 408. Thereafter, the NAND controller 21 starts again the data transfer from the NAND chip 11.

According to the third embodiment, it becomes not necessary to read the data again from the NAND chips 11 to 1n when the data transfer is started again after the interruption of the data transfer by providing the pool buffers 81 to 8n between the application layer 4 and the NAND controllers 21 to 2n, respectively, and it becomes possible to improve data transfer efficiency from a back end to a front end of the memory system 22.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A control method of a memory system comprising a non-volatile storage unit, a first buffer, a second buffer, and a first port, the first port being capable of communicating with a first host, the control method comprising:
reading first read data from the non-volatile storage unit when receiving a read request from the first host;
storing the first read data in the first buffer and the second buffer in first management unit;
transferring, when first data in second management unit is stored in the second buffer, the first data stored in the second buffer to the first host through the first port, the second management unit being larger than the first management unit; and
after the transfer, deleting second data stored in the first buffer, the second data being the same data as the transferred first data, and storing second read data in the first buffer and the second buffer in the first management unit, the second read data following the first read data.

2. The control method of the memory system according to claim 1, comprising:
discarding, when an interruption occurs when first remaining data smaller than the second management unit is stored in the second buffer, the first remaining data in the second buffer.

3. The control method of the memory system according to claim 2, comprising:
copying second remaining data stored in the first buffer to the second buffer after data transfer is restarted after the interruption.

4. The control method of the memory system according to claim 3, comprising:
storing the second read data in both the first buffer and the second buffer in the first management unit after the copy, and transferring, when the data in the second management unit is stored in the second buffer, the third data in the second buffer to the first host.

5. The control method of the memory system according to claim 2, the memory system further comprising a second port capable of communicating with a second host, and a third buffer, the control method comprising:
reading third read data from the non-volatile storage unit when the read request is received from the second host;
storing the third read data in the first buffer and the third buffer in the first management unit;
transferring, when fourth data in the second management unit is stored in the third buffer, the fourth data stored in the third buffer to the second host through the second port; and
after the transfer, deleting fifth data stored in the first buffer, the fifth data being the same data as the transferred fourth data, and storing fourth read data in the first buffer and the third buffer in the first management unit, the fourth read data following the third read data.

6. The control method of the memory system according to claim 5, wherein the first host and the second host are the same, the method further comprising:
copying, when receiving the read request through the first port, the third remaining data stored in the second buffer to the third buffer after the interruption and deleting the third remaining data in the second buffer, when the interruption occurs in a state in which the third remaining data smaller than the second management unit is stored in the second buffer.

7. The control method of the memory system according to claim 6, comprising:
storing the following read data in the first buffer and the third buffer in the first management unit after the copy; and
transferring, when sixth data in the second management unit is stored in the third buffer, the sixth data in the third buffer through the second port.

8. The control method of the memory system according to claim 1, the memory system further comprising a fourth buffer and a fifth buffer, the control method comprising:
storing the first read data in the fourth buffer and the fifth buffer in third management unit, the third management unit being twice or larger natural number times as large as the first management unit;
discarding the first read data stored in the fifth buffer after confirming that the first read data in the third management unit is stored in the fourth buffer; and
storing the first read data stored in the fourth buffer in the first buffer and the second buffer in the first management unit.

9. The control method of the memory system according to claim 8, the control method comprising:
when reading from the non-volatile storage unit is interrupted before a size of the first read data stored in the fourth buffer reaches the third management unit, not discarding the first read data stored in the fifth buffer; and
copying the first read data stored in the fifth buffer to the fourth buffer after data transfer is restarted after the interruption.

10. The control method of the memory system according to claim 2, wherein
the interruption is caused by an instruction from the first host or occurrence of a read error from the non-volatile storage unit.

11. A memory system comprising:
a non-volatile storage unit;
a first buffer;
a second buffer;
a first port capable of communicating with a first host; and
a controller configured to:
read first read data from the non-volatile storage unit when receiving a read request from the first host;
store the first read data in the first buffer and the second buffer in first management unit;
transfer, when first data in second management unit is stored in the second buffer, the first data stored in the second buffer to the first host through the first port, the second management unit being larger than the first management unit; and
after the transfer, delete second data stored in the first buffer, the second data being the same data as the transferred first data, and store second read data in the first buffer and the second buffer in the first management unit, the second read data following the first read data.

12. The memory system according to claim 11, wherein
the controller is configured to discard, when an interruption occurs when first remaining data smaller than the second management unit is stored in the second buffer, the first remaining data in the second buffer.

13. The memory system according to claim 12, wherein
the controller is configured to copy the second remaining data stored in the first buffer to the second buffer after data transfer is restarted after the interruption.

14. The memory system according to claim 13, wherein
the controller is configured to store the second read data in both the first buffer and the second buffer in the first management unit after the copy, and transfer, when the data in the second management unit is stored in the second buffer, the third data in the second buffer to the first host.

15. The memory system according to claim 12, further comprising:
a second port capable of communicating with a second host; and
a third buffer, wherein
the controller is configured to:
read third read data from the non-volatile storage unit when the read request is received from the second host;
store the third read data in the first buffer and the third buffer in the first management unit;
transfer, when fourth data in the second management unit is stored in the third buffer, the fourth data stored in the third buffer to the second host through the second port; and
after the transfer, delete fifth data stored in the first buffer, the fifth data being the same data as the transferred fourth data, and store fourth read data in the first buffer and the third buffer in the first management unit, the fourth read data following the third read data.

16. The memory system according to claim 15, wherein the first host and the second host are the same, wherein
the controller is configured to copy, when receiving the read request through the first port, the third remaining data stored in the second buffer to the third buffer after the interruption and delete the third remaining data in the second buffer, when the interruption occurs in a state in which the third remaining data smaller than the second management unit is stored in the second buffer.

17. The memory system according to claim 16, wherein
the controller is configured to:
store the following read data in the first buffer and the third buffer in the first management unit after the copy; and
transfer, when sixth data in the second management unit is stored in the third buffer, the sixth data in the third buffer through the second port.

18. The memory system according to claim 11, further comprising:
a fourth buffer; and
a fifth buffer, wherein
the controller is configured to:
store the first read data in the fourth buffer and the fifth buffer in third management unit, the third management unit being twice or larger natural number times as large as the first management unit;
discard the first read data stored in the fifth buffer after confirming that the first read data in the third management unit is stored in the fourth buffer; and
store the first read data stored in the fourth buffer in the first buffer and the second buffer in the first management unit.

19. The memory system according to claim 18, wherein
the controller is configured to:
when reading from the non-volatile storage unit is interrupted before a size of the first read data stored in the fourth buffer reaches the third management unit, not discard the first read data stored in the fifth buffer; and
copy the first read data stored in the fifth buffer to the fourth buffer after data transfer is restarted after the interruption.

20. The memory system according to claim 12, wherein
the interruption is caused by an instruction from the first host or occurrence of a read error from the non-volatile storage unit.
